(19) United States
(12) Patent Application Publication
(10) Pub. No.: US 2019/0193339 A1
(43) Pub. Date: Jun. 27, 2019

(54) LASER-INDUCED MICRO-ANCHOR STRUCTURAL AND PASSIVATION LAYER FOR METAL-POLYMERIC COMPOSITE JOINING AND METHODS FOR MANUFACTURING THEREOF

(71) Applicant: GM Global Technology Operations LLC, Detroit, MI (US)

(72) Inventors: Hongliang Wang, Sterling Heights, MI (US); Xingcheng Xiao, Troy, MI (US); Guoxian Xiao, Troy, MI (US); Jorge F. Arinez, Rochester Hills, MI (US); Hua-tzu Fan, Warren, MI (US)

(73) Assignee: GM Global Technology Operations LLC, Detroit, MI (US)

(21) Appl. No.: 15/849,956

(22) Filed: Dec. 21, 2017

(51) Int. Cl. B29C 65/00; B32B 3/06; B32B 3/30; B32B 15/088; B32B 27/06; B32B 27/34; B32B 37/06; B29C 65/02

(52) U.S. Cl. CPC B29C 66/303; B29K 2077/00; B32B 3/30; B32B 15/088; B32B 27/06; B32B 27/34; B32B 37/06; B29C 65/02; B29C 66/7212; B29C 66/7422; B32B 2255/06; B32B 2262/106; B32B 2307/202; B32B 2307/542; B32B 2311/24; B32B 2377/00; B32B 3/06

(57) ABSTRACT

The present disclosure provides a metal-polymeric composite joint including a first component and a second component. The first component includes a metal. The first component has a first surface including a plurality of micro-anchors. The second component includes a composite material including a polymer and a reinforcing fiber. The second component has a second surface that at least partially engages the first surface of the first component. A portion of the polymer of the second component occupies at least a portion of the micro-anchors of the first component to fix the second component to the first component. In one aspect, the metal-polymeric composite joint further includes a passivation layer disposed between the first surface of the first component and the second surface of the second component.

### INTRODUCTION

This section provides background information related to the present disclosure which is not necessarily prior art.

The present disclosure pertains to a metal-polymeric composite joint and methods of manufacturing the metal-polymeric composite joint. More specifically, the metal-polymeric composite joint may include a laser-induced micro-anchor structural and passivation layer.

Weight reduction for increased fuel economy in vehicles has spurred the use of various lightweight materials, such as aluminum and magnesium alloys as well as use of light-weight reinforced composite materials. While use of such lightweight materials can serve to reduce overall weight and generally improve fuel efficiency, issues can arise in manufacturing certain components. For example, molding large, complex parts from a reinforced composite material may be difficult or infeasible. It may therefore be desirable to join multiple smaller components. However, joining dissimilar materials, such as a metal and a reinforced polymeric composite, may present additional challenges such as low-strength joints or long cycle times in manufacturing. Accordingly, it would be desirable to develop a quick and robust method of joining metal and composite components.

### SUMMARY

This section provides a general summary of the disclosure, and is not a comprehensive disclosure of its full scope or all of its features.

In various aspects, the present disclosure provides a metal-polymeric composite joint. The metal-polymeric composite joint includes a first component and a second component. The first component includes a metal. The first component has a first surface including a plurality of micro-anchors. The second component includes a composite material including a polymer and a reinforcing fiber. The second component has a second surface that at least partially engages the first surface of the first component. A portion of the polymer of the second component occupies at least a portion of the micro-anchors of the first component to fix the second component to the first component.

In one aspect, the first surface further defines a plurality of crests and a plurality of troughs. The plurality of crests defines the plurality of micro-anchors.

In one aspect, the first surface further defines a plurality of elongate valleys and a plurality of elongate peaks. The elongate valleys are disposed between the elongate peaks. A portion of the crests and a portion of the troughs are disposed on each elongate valley. A portion of the crests and a portion of the troughs are disposed on each elongate peak.

In one aspect, the plurality of elongate valleys and the plurality of elongate peaks are disposed parallel to one another, and the metal-polymeric composite joint can withstand loads of greater than or equal to about 6 kN in a direction perpendicular to the elongate valleys and the elongate peaks.

In one aspect, the metal is selected from a group consisting of stainless steel, aluminum, and combinations thereof.

In one aspect, the metal includes aluminum. The first surface is at least partially coated in a passivation layer including aluminum oxide (Al₂O₃).

In one aspect, the polymer is selected from the group consisting of a polycarbonate (PC), a high-density polyethylene (HDPE), polyoxymethylene (POM), a thermoplastic elastomer (TPE), acrylonitrile butadiene styrene (ABS), a thermoplastic olefin (TPO), a polyamide (PA, nylon), and combinations thereof.

In one aspect, the metal includes aluminum, the polymer includes polyamide (PA, nylon), and the reinforcing fiber includes a carbon fiber.

In one aspect, at least a portion of the micro-anchors include micro-apertures. Each micro-aperture has perimeter defining a connected shape.

In various other aspects, the present disclosure provides another metal-polymeric composite joint. The metal-polymeric composite joint includes a first component, a second component, and a passivation layer. The first component includes aluminum and has a first surface. The second component is fixed to the first component. The second component includes a composite including a polymer and a reinforcing fiber. The second component has a second surface that at least partially engages the first surface of the first component. The passivation layer is disposed on the first surface of the first component. The passivation layer engages the second surface of the second component. The passivation layer includes aluminum oxide (Al₂O₃). The metal-polymeric composite joint has a lap shear strength of greater than or equal to about 6 kN after 5 years.

In one aspect, the passivation layer has an average atomic percent of oxygen of greater than or equal to about 10% at a depth of 500 nm measured from the first surface of the first component.

In yet other aspects, the present disclosure provides a method of joining dissimilar materials. The method includes directing a first laser beam toward a first surface of a first component to form a plurality of micro-anchors in the first surface. The first component includes a metal. The method also includes disposing the first component on a second component so that the first surface of the first component at least partially engages a second surface of the second component. The second component includes a composite including a polymer and a reinforcing fiber. The method also includes directing a heat source towards a third surface of the first component to cause a portion of the polymer to melt and occupy a portion of the micro-anchors. The third surface is disposed opposite the first surface.

In one aspect, the first component includes metal and directing the first laser beam toward the first surface of the first component is performed in the presence of oxygen to form an aluminum oxide (Al₂O₃) layer on the first surface.

In one aspect, directing the heat source toward the third surface of the first component includes directing a second laser beam toward the third surface of the first component. The second laser beam is a continuous wave (CW) laser beam.

In one aspect, the second laser beam has a power of greater than or equal to about 500 W and less than or equal to about 2000 W. The second laser beam has a scan speed of greater than or equal to about 100 mm/s and less than or equal to about 2 m/s. The second laser beam has a spot size of greater than or equal to about 100 μm and less than or equal to about 500 μm.

In one aspect, directing the second laser beam toward the third surface of the first component includes moving the second laser beam with respect to the first component to create a first plurality of elongate valleys on the third surface. Each elongate valley is disposed substantially parallel to the other elongate valleys. A centerline each elongate valley is disposed greater than or equal to about 0.5 mm and less than or equal to about 5 mm from the centerline of each other elongate valley.

In one aspect, directing the second laser beam toward the third surface of the first component further includes moving the second laser beam with respect to the first component to create a second plurality of elongate valleys on the third surface. Each elongate valley of the second plurality of elongate valleys is disposed substantially parallel to the other elongate valleys of the second plurality of elongate valleys. A centerline each elongate valley of the second plurality of elongate valleys is disposed greater than or equal to about 0.5 mm and less than or equal to about 5 mm from the centerline of each other elongate valley of the second plurality of elongate valleys. The elongate valleys of the second plurality of elongate valleys are disposed between the elongate valleys of the first plurality of elongate valleys.

In one aspect, the first laser beam is a nanosecond pulsed laser beam having a pulse width of greater than or equal to about 9 ns and less than or equal to about 200 ns. The first laser beam has a pulse overlap of greater than or equal to about 0% and less than or equal to about 50%. The first laser beam has a repetition rate of greater than or equal to about 10 kHz and less than or equal to about 500 kHz.

In one aspect, the first laser beam has a scan power of greater than or equal to about 50 W and less than or equal to about 500 W. The first laser beam has a scan speed of greater than or equal to about 100 mm/s and less than or equal to about 10 m/s. The first laser beam has a spot size of greater than or equal to about 10 μm and less than or equal to about 100 μm.

In one aspect, the metal includes aluminum, the polymer includes polyamide (PA, nylon), and the reinforcing fiber includes carbon fiber.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C show a metal-polymeric composite joint according to certain aspects of the present disclosure. FIG. 1A is a side view of the metal-polymeric composite joint; FIG. 1B is a top view of the metal-polymeric composite joint; FIG. 1C is a sectional view of the metal-polymeric joint of FIG. 1A taken at line 1C-1C of FIG. 1B;

FIGS. 2A-2E are scanning electron microscopy (“SEM”) images of a laser-treated metal surface according to certain aspects of the present disclosure; FIGS. 2A-2B are top views of the laser-treated metal surface showing a plurality of peaks and a plurality of valleys; FIG. 2C is a side perspective view of the laser-treated metal surface showing a plurality of troughs, a plurality of crests, and a plurality of micro-anchors; FIGS. 2D-2E are top views of the laser-treated surface showing the plurality of troughs, the plurality of crests, and the plurality of micro-anchors;

FIG. 3 is an SEM image of a metal-polymeric composite joint including the laser-treated aluminum surface of FIGS. 2A-2E;

FIG. 4 is a schematic of a method of laser-treatment of a metal component according to certain aspects of the present disclosure;

FIG. 5 is a top view of the metal component of FIG. 4 showing a laser pattern according to certain aspects of the present disclosure;

FIG. 6 is a schematic of a joining process for forming a metal-polymeric composite joint according to certain aspects of the present disclosure;

FIG. 7 is a top view of the metal-polymeric composite joint of FIG. 6 showing a laser pattern according to certain aspects of the present disclosure;

FIG. 8 shows alternative laser patterns for a laser-treatment process according to certain aspects of the present disclosure. FIG. 8 is a top view of a metal component showing a laser pattern for forming a joint having high lap shear strength in two directions;

FIGS. 9A-9B show alternative laser patterns for a laser-treatment process according to certain aspects of the present disclosure. FIG. 9A is a top view of a metal component showing a laser pattern for forming a joint having 360° high lap shear strength; FIG. 9B is a sectional view of the metal component of FIG. 9A taken at line 9B-9B of FIG. 9A;

FIG. 10 shows x-ray photoelectron spectroscopy (XPS) depth profiles of (i) an aluminum component without a laser-treated surface and (ii) an aluminum component having a laser-treated surface according to certain aspects of the present disclosure;

FIG. 11 is a top view of an aluminum-polymeric composite joint prior to corrosion testing of a metal-polymeric composite joint;

FIG. 12 is a top view of an aluminum-polymeric composite joint after 2.5 years of corrosion;

FIG. 13 is a graphical representation of lap shear strength as a function of time for metal-polymeric composite joints including: (i) an aluminum component without a laser-treated surface, (ii) an aluminum component having a laser-treated surface, and (iii) a stainless steel component having a laser-treated surface; and

FIG. 14 is a graphical representation of degradation of lap shear force as a function of time for the aluminum-polymeric composite joints of FIG. 13.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

As discussed above, joining dissimilar materials, such as metals and polymeric composites, may present certain challenges. One possible method of joining a metal component and a polymeric composite component includes applying an adhesive to the joint and then curing the adhesive. However, adhesive joining of metals and polymeric composites poses challenges for mass production because of the relatively long cure time. For example, a duration of curing may be on the order of magnitude of hours.

Another possible method of joining a metal component and a polymeric composite component includes welding the joint (e.g., ultra-sonic welding, laser welding, etc.). However, welded metal and polymeric composite joints may have an undesirably low strength, because the materials are not readily chemically bonded to one another.

In various aspects, the present disclosure provides a high-strength metal-polymeric composite joint. The joint may include a metal component having a first surface that defines a plurality of micro-anchors or openings, which will be described further below. The first surface of the metal component may engage a second surface a reinforced polymeric composite component. A polymer of the polymeric composite component may occupy a space defined by the micro-anchors so that the polymer is disposed within and therefore intertwined with the micro-anchors to create a robust mechanical joint. The joint prepared according to certain aspects of the present disclosure may have a lap shear strength of greater than or equal to about 6 kN, optionally greater than or equal to about 7 kN, optionally greater than or equal to about 8 kN, optionally greater than or equal to about 9 kN, optionally greater than or equal to about 9.1 kN, optionally greater than or equal to about 9.2 kN, optionally greater than or equal to about 9.3 kN, and optionally greater than or equal to about 9.4 kN.

In various aspects, the present disclosure also provides corrosion-resistant metal-polymeric composite joint. The joint may include a passivation layer disposed between a metal component and a reinforced polymeric composite component. For example, when the metal component includes aluminum, the passivation layer may include aluminum oxide (Al₂O₃). The passivation layer may be intentionally formed by heating the aluminum in the presence of oxygen. The passivation layer may reduce corrosion at the joint, thereby prolonging a life of the joint. After 2.5 years, the joint may have a lap shear strength of greater than or equal to about 6 kN, optionally greater than or equal to about 6.5 kN, optionally greater than or equal to about 7.0 kN, optionally greater than or equal to about 7.5 kN, and optionally greater than or equal to about 7.7 kN. After 5 years, the joint may have a lap shear strength of greater than or equal to about 6 kN, optionally greater than or equal to about 6.1 kN, optionally greater than or equal to about 6.2 kN, optionally greater than or equal to about 6.3 kN, optionally greater than or equal to about 6.4 kN, optionally greater than or equal to about 6.5 kN, optionally greater than or equal to about 6.6 kN, optionally greater than or equal to about 6.7 kN, optionally greater than or equal to about 6.8 kN, and optionally greater than or equal to about 6.9 kN.

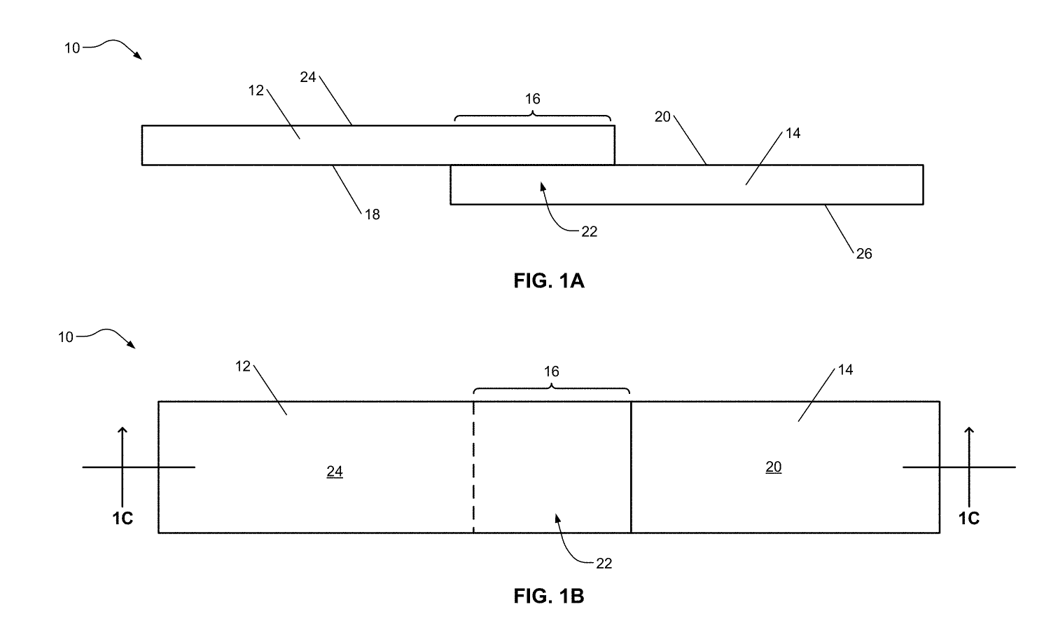

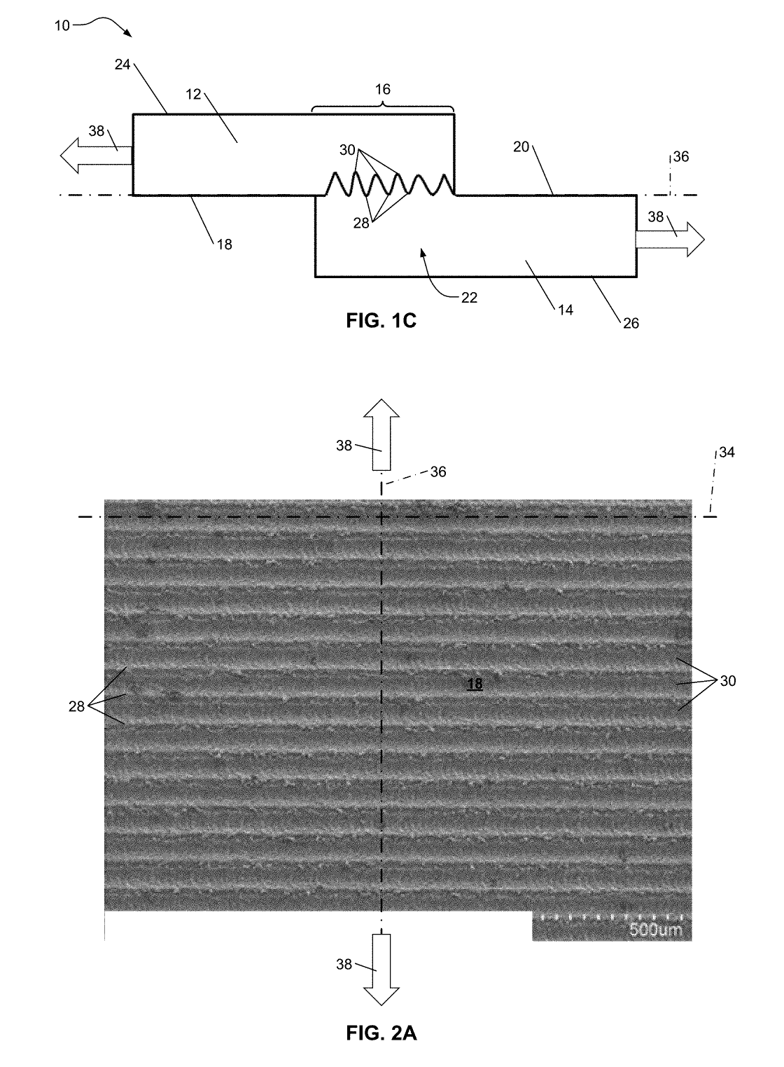

Referring to FIGS. 1A-1C, a metal-polymeric composite assembly 10 according to certain aspects of the present disclosure is provided. The metal-polymeric composite assembly 10 includes a metal component 12 (or first component) and a reinforced polymeric composite component 14 (or second component). The metal component 12 and the reinforced polymeric composite component 14 may overlap at a joining region 16. More specifically, a first surface 18 of the metal component 12 and a second surface 20 of the reinforced polymeric composite component 14 may directly engage or contact one another at the joining region 16. The metal component 12 and the reinforced polymeric composite component 14 may be fixed to one another in the joining region 16 to form a metal-polymeric composite joint 22. The metal component 12 may include a third surface 24 disposed opposite the first surface 18. The reinforced polymeric composite component 14 may include a fourth surface 26 disposed opposite the second surface 20.

In certain variations, the metal component 12 may include aluminum, stainless steel (e.g., 316 stainless steel), or combinations thereof. The reinforced polymeric composite component 14 may include a polymer and a reinforcing material. The polymer may be a thermoplastic polymer. As non-limiting examples, the polymer may include a polycarbonate (PC), a high-density polyethylene (HDPE), acetal or polyoxymethylene (POM), a thermoplastic elastomer (TPE), acrylonitrile butadiene styrene (ABS), a thermoplastic olefin (TPO), a polyamide (PA, nylon), and combinations thereof. In certain variations, the reinforcing material may include a fiber such as carbon fiber (e.g., powdered fiber, short fiber, long fiber, or continuous fiber) or a glass fiber.

As best shown in FIG. 1C, at least a portion of the first surface 18 of the metal component 12 may include a plurality of elongate peaks 28 and a plurality of elongate valleys 30. The elongate peaks 28 and elongate valleys 30 may be present on the first surface 18 in the joining region 16, or where the first surface 18 of the metal component 12 engages the second surface 20 of the reinforced polymeric composite component 14. The plurality of elongate valleys 30 may be disposed between the plurality of elongate peaks 28 so that the elongate peaks 28 and the elongate valleys 30 alternate with one another in the joining region 16.

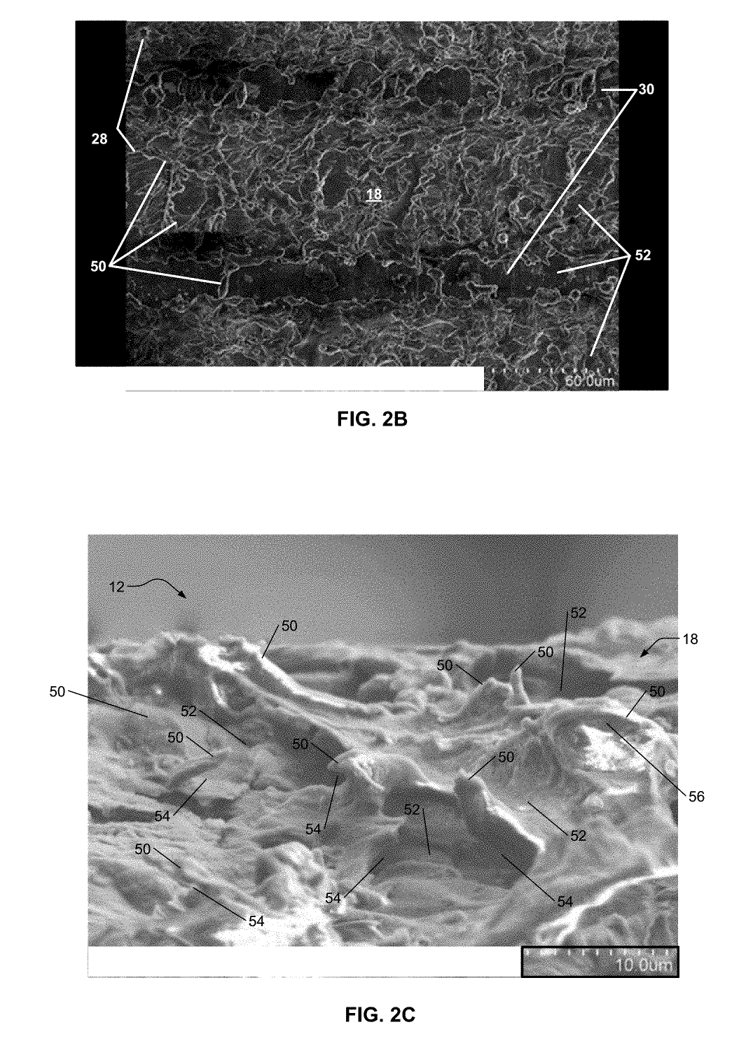

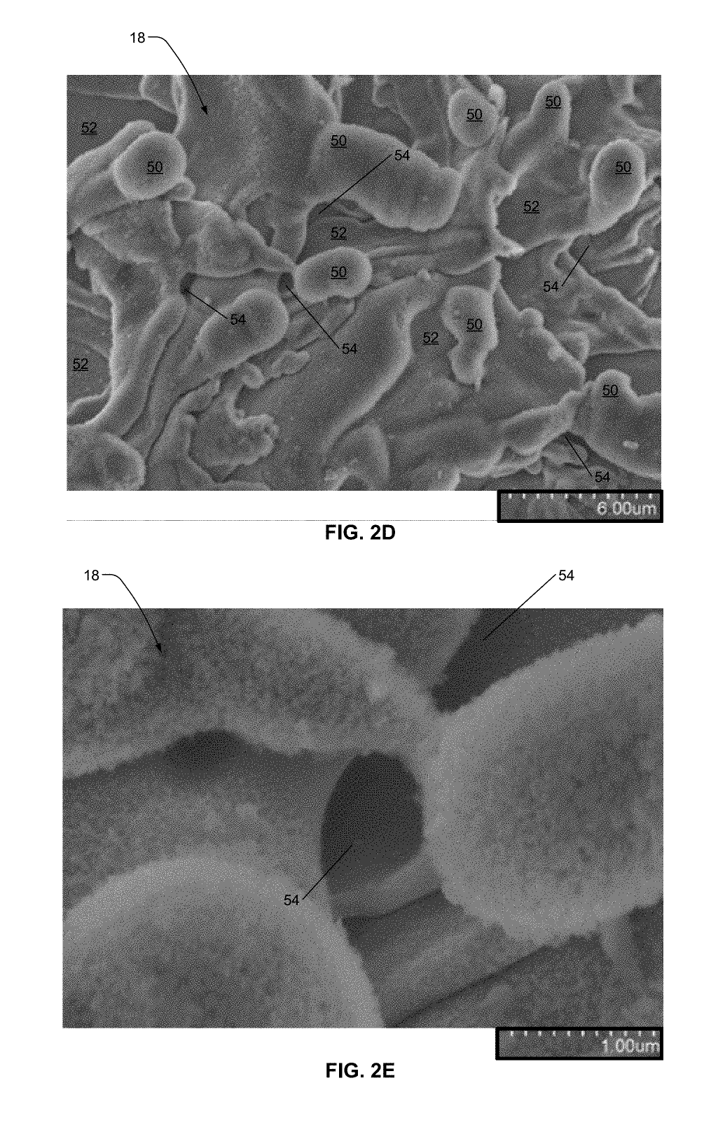

Referring to FIGS. 2A-2B, each elongate peak 28 may be disposed substantially parallel to each other elongate peak 28. Similarly, each elongate valley 30 may be disposed substantially parallel to each other elongate valley 30. The elongate valleys 30 may be substantially evenly disposed within the joining region 16 of the metal-polymeric composite assembly 10. In other variations, the elongate valleys 30 may be unevenly spaced. For example, the elongate valleys 30 may be disposed in smaller subgroups (e.g., subgroups of five elongate valleys 30 in close proximity spaced apart from other subgroups) (not shown).

The elongate peaks 28 and elongate valleys 30 may extend parallel to a first axis 34. The first axis 34 may be substantially perpendicular to a second axis 36. The second axis 36 may correspond to a direction of applied force as indicated by the arrows 38. The arrangement of the elongate peaks 28 and elongate valleys 30 may result in a lap shear strength of the joint 22 being greatest along the second axis 36 because of a mechanical interaction of the elongate peaks 28 and elongate valleys 30 of the first surface 18 with the second surface 20 as the force 38 is applied.

The elongate peaks 28 and elongate valleys 30 may be formed by laser treating the first surface 18 (referred to as a laser treatment or surface ablation process). The laser treatment may include directing a laser beam at the first surface 18 of the metal component 12. As discussed in greater detail below, the laser beam moves relative to the metal component 12 to create the plurality of elongate valleys 30. The elongate peaks 28 are defined on areas of the first surface 18 adjacent to the laser-created elongate valleys 30. As the elongate valleys 30 are created by moving the laser beam over the first surface 18, the laser beam heats the first surface 18, thereby liquefying a portion of the metal at the first surface 18 of the metal component 12. The laser beam may be a nanosecond pulsed laser. Thus, during a laser pulse, the laser beam may melt the metal. The liquefied metal may cool and solidify during a time between laser beam pulses. The relatively-short nanosecond pulse may lead to a dynamic heating and cooling process so that the molten metal solidifies before it can reach equilibrium and settle to form a smooth surface. Such a dynamic heating and cooling process may facilitate the formation of a specialized rough or irregular topography on the first surface 18 of the metal component 12, as discussed further herein.

With reference to FIGS. 2B-2E, the first surface 18 of the metal component 12 is shown. The first surface 18 includes a plurality of crests 50 and a plurality of troughs 52. At least at least a portion of the crests 50 and at least a portion of the troughs 52 may be defined on each elongate peak 28. At least a portion of the crests 50 and at least a portion of the troughs 52 may be defined on each elongate valley 30. The crests 50 and troughs 52 are created as the metal of the metal component 12 rapidly melts and solidifies during the dynamic heating and cooling process. A pattern of crests 50 and troughs 52 may be irregular. Dimensions of the crests 50 and elongate troughs 50 may also be irregular. For example, crests 50 may differ from one another in size and shape. Troughs 52 may similarly differ from one another in size and shape. By way of non-limiting example, an average roughness of the first surface 18 may be greater than or equal to about 5 μm and less than or equal to about 20 μm.

At least a portion of the crests 50 may also include a plurality of micro-anchors 54. The micro-anchors 54 may include invaginations, cavities, pores, hooks, and/or undercut regions that are formed during the cooling process. More specifically, the micro-anchors are formed after liquefied metal rises to define a crest 50 that then collapses back toward the first surface 18. The lasers used in accordance with certain aspects of the present disclosure enable the formation of such micro-anchor structures by melting and then rapidly solidifying the metal to facilitate formation of such complex structures desirably having extensions that are at an angle (e.g., substantially perpendicular) to the metal surface so as to form undercuts or protrusions that serve as anchoring regions for polymer (as compared to merely creating surface roughness/asperities formed by typical roughening techniques). A portion of the micro-anchors 54 may be micro-apertures or micro-openings 56 having perimeters defining connected shapes, as best shown in FIG. 2C. A micro-aperture or micro-opening 56 is formed when solid material (i.e., the metal) extends around an entire perimeter of the micro-aperture 56. Thus, a perimeter of the micro-aperture 56 may be substantially free of gaps. The micro-anchors 54 may be irregular in size, shape, and distribution. In certain variations, the micro-anchors 54 may overlap one another.

The topography of the first surface 18, including the crests 50, the troughs 52, and the micro-anchors 54, may increase an area of the first surface 18 to facilitate intimate contact between the first surface 18 and a mating surface (e.g., the second surface 20 of the reinforced polymer composite component 14). Additionally, the micro-anchors 54 may enable a strong mechanical interlock with the mating surface. More particularly, as discussed in greater detail below, a material of the mating surface may engage the micro-anchors 54 to mechanically lock the metal component 12 to a mating component (e.g., the reinforced polymer composite component 14).

The metal-polymeric composite assembly 10 may be particularly prone to corrosion at the joint 22 when the reinforced polymeric composite component 14 includes a conductive material. For example, the use of carbon fiber as the reinforcing material makes the reinforced polymeric composite component 14 electrically conductive. Because carbon fibers are very inert or noble when compared to certain metals, such as aluminum, a metal component that is electrically connected to a carbon fiber composite may be particularly prone to galvanic corrosion. Thus, even when the joint 22 has a high initial strength, it may rapidly deteriorate and decrease in strength due to the galvanic corrosion. In various aspects, the present disclosure provides a corrosion-resistant joint having a passivation layer disposed between the metal component 12 and the reinforced polymeric composite component 14. The passivation layer may act as a protective layer to prevent or reduce corrosion of the joint 22.

The passivation layer may be formed during the laser-treatment that creates the elongate peaks 28 and valleys 30. That is, the formation of the elongate peaks 28 and valleys 30 may be concurrent with the formation of the passivation layer. The laser treatment may be performed in the presence of oxygen to facilitate the formation of the passivation layer on the first surface 18 of the metal component 12. Whether the passivation layer is formed at all may depend on the composition of the metal component 12 and whether oxygen is present during the laser treatment. A thickness of the passivation layer may depend on the temperature of the first surface 18 during the laser treatment. In one example, the metal component 12 includes aluminum and the laser beam is directed at the first surface 18 in the presence of oxygen (e.g., ambient atmosphere) to form a passivation layer that includes aluminum oxide (Al₂O₃). Aluminum oxide (Al₂O₃) is a stable, nonconductive dielectric that can be used as a coating to reduce corrosion at the joint 22.

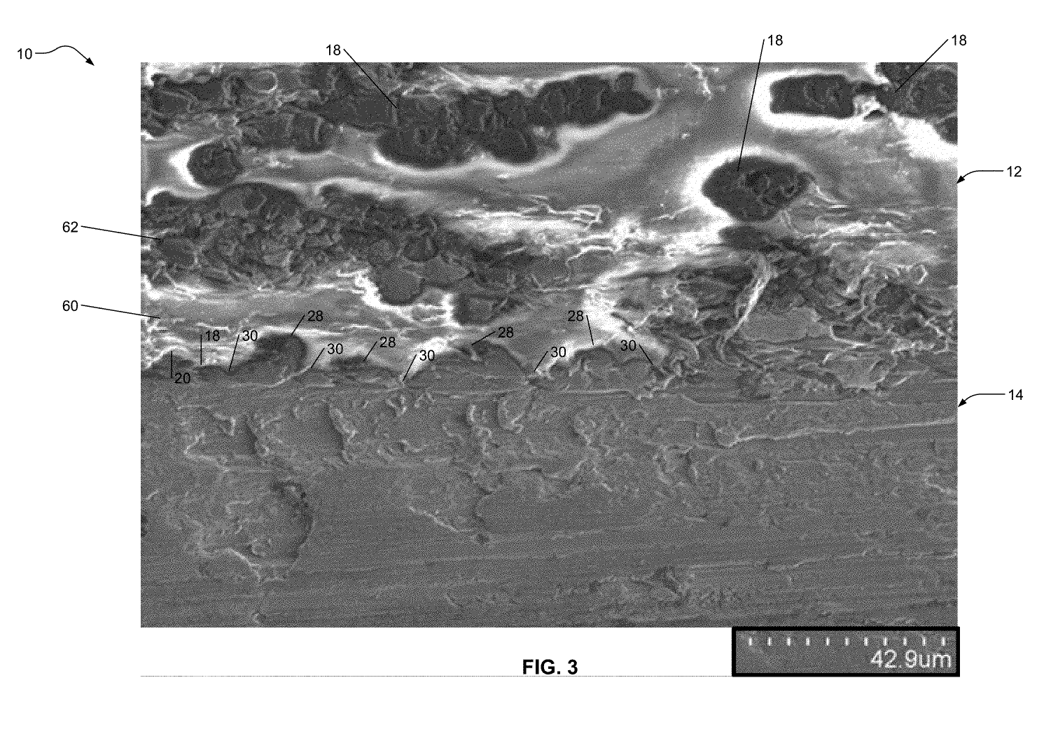

Referring to FIG. 3, an example of the joint 22 including the metal component 12 and the reinforced polymeric composite component 14 is shown. The metal component 12 may include aluminum. The reinforced polymeric composite component 14 may include a polymer material 60 and a plurality of reinforcing fibers 62. The polymer may be polyamide (PA, nylon) and the reinforcing fiber may include carbon fibers. The first surface 18 may include the elongate peaks 28 and the elongate valleys 30. The polymer 60 at the second surface 20 of the reinforced polymeric composite component 14 may be in intimate contact with the first surface 18 of the metal component 12. Thus, in certain embodiments, the joint 22 may be free of any interfacial delamination.

The joint 22 between the metal component 12 and the reinforced polymeric composite component 14 may be formed by applying heat at the joining region 16 (FIGS. 1A-1C). More particularly, after the metal component 12 has been laser treated as described above, it may be at least partially disposed on the reinforced polymeric composite component 14 so that the first surface 18 (i.e., the laser-treated surface) of the metal component 12 directly engages the second surface 20 of the reinforced polymeric composite component 14. A heat source, such as a laser beam, may be directed toward the third surface 24 of the metal component 12. This process may create a plurality of elongate valleys or grooves similar to the elongate valleys 30 of the laser-treatment process. Due to the high conductivity of the metal, the heat may be transferred through the metal component 12 from the third surface 24 to toward the cooler first surface 18. The heat at the first surface 18 may cause the polymer 60 at the adjacent second surface 20 to melt. The melted polymer 60 may flow around the crests 50, into the troughs 52, and through the micro-anchors 54. The metal may have a higher melting temperature than the polymer, thus, the metal at the first surface 18 may remain in solid form while a portion of the polymer 60 (i.e., the polymer 60 near the second surface 20) melts to flow through the micro-anchors 54. The polymer 60 may at least partially occupy at least a portion of the micro-anchors 54. In certain variations, the polymer 60 may fully occupy at least a portion of the micro-anchors 54. In certain variations, the polymer 60 may fully occupy all of the micro-anchors 54. Although the heat source is described as a laser beam, one skilled in the art would appreciate that the joining region 16 may alternatively be exposed to a torch, induction heating, or ultrasonic welding, by way of non-limiting example.

The polymer 60 may cool and solidify when the application of heat ceases. The solidified polymer 60 may be intertwined with the metal of the metal component 12. For example, the polymer 60 may occupy the micro-anchors 54 to form hooks or loops around the micro-anchors 54. The polymer hooks or loops can mechanically interact with the micro-anchors 54 to form a strong joint. In certain variations, the joint 22 may behave like a hook-and-loop fastener; however, unlike a typical hook-and-loop fastener, the joint 22 is permanent so that the metal component 12 cannot be readily peeled away from the reinforced polymeric composite component 14.

In various aspects, the present disclosure provides a method of manufacturing a metal-polymeric composite joint. The method may include laser-treating a first surface of a metal component. The laser treatment may create a plurality of micro-anchors, such as micro-apertures on the first surface. In certain variations, when the laser treatment is performed in the presence of oxygen, a passivation layer may be formed on the first surface. The laser treatment and formation of the passivation layer may be performed as a one-step process or concurrently. For example, when the metal component includes aluminum, the laser treatment may facilitate formation of an aluminum oxide (Al₂O₃) passivation layer. The method may further include disposing a second surface of a polymeric composite component on the first surface of the metal component. Heat, such as from a laser, may be applied to a third surface of the metal component opposite the first surface to join the metal component to the polymeric composite component. More specifically, the heat may be transferred through the metal component, from the third surface to the first surface, to melt a polymer of the polymeric composite at the second surface. The melted polymer may flow through the micro-anchors and solidify to occupy the micro-anchors to form a high-strength metal-polymeric composite joint. The method may have a cycle time on the order of magnitude of seconds. In certain variations, the same laser equipment may be used for the laser treatment process as for the joining process.

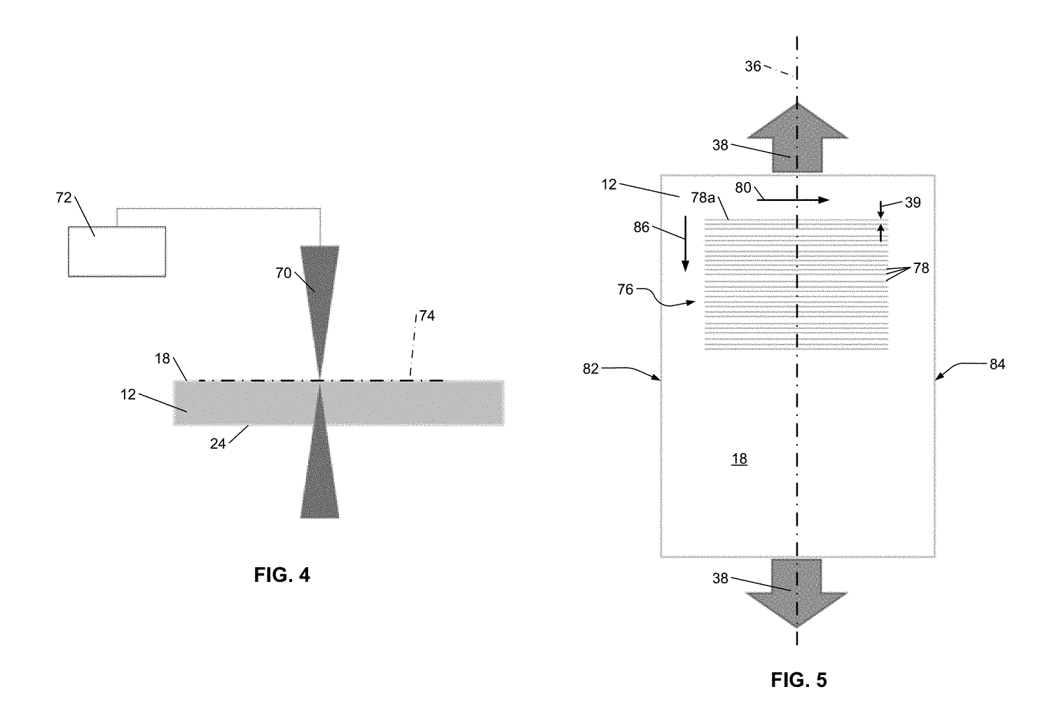

Referring to FIGS. 4-7, a method of manufacturing a metal-polymeric composite assembly is shown. The method is described with reference to the metal-polymeric composite assembly 10 of FIGS. 1A-3. Referring now to FIGS. 4-5, the method includes laser-treating the first surface 18 of the metal component 12. Laser-treating the first surface 18 includes directing a first laser beam 70 from a laser source 72 towards the first surface 18. A first focal plane 74 of the first laser beam 70 is aligned at the first surface 18. The first laser beam 70 may be focused toward the first surface 18 to achieve the highest laser fluence possible in light of the other laser-treatment parameters.

The first laser beam 70 may be a nanosecond pulsed laser beam. The first laser beam 70 may have a pulse width of greater than or equal to about 9 ns and less than or equal to about 200 ns, optionally greater than or equal to about 50 ns and less than or equal to about 200 ns, optionally greater than or equal to about 100 ns and less than or equal to about 200 ns, and optionally about 200 ns. The first laser beam 70 may have a pulse overlap of greater than or equal to about 0% and less than or equal to about 50%, optionally greater than or equal to about 5% and less than or equal to about 45%, optionally greater than or equal to about 10% and less than or equal to about 40%, and optionally about 35%. The first laser beam may have a repetition rate of greater than or equal to about 10 kHz and less than or equal to about 500 kHz, optionally greater than or equal to about 100 kHz and less than or equal to about 400 kHz, optionally greater than or equal to about 150 kHz and less than or equal to about 300 kHz, and optionally about 200 kHz.

The first laser beam 70 may move relative to the metal component 12 to create a first laser pattern 76. For example, a laser head may move the first laser beam 70 while the metal component 12 remains stationary. In another example, the metal component 12 may be moved while the laser head remains stationary. The first laser pattern 76 may include a plurality of parallel lines 78 (resulting in the plurality of elongate valleys 30). In one example, the first laser beam 70 may be moved in a first direction 80, from a first end 82 of the metal component 12 to a second end 84 of the metal component 12 to create a first line 78a. The laser head may then return to the first end 82 and move in a second direction 86 substantially perpendicular to the first direction 80 to a starting position to create another line 78 adjacent to the first line 78a. The process may be repeated to create the first laser pattern 76.

The lines 78 of the first laser pattern 76 may be disposed substantially perpendicular to the second axis 36, which is aligned with a direction of the applied force 38. The first laser beam may create a spot size of greater than or equal to about 10 μm and less than or equal to about 100 μm, optionally greater than or equal to about 30 μm and less than or equal to about 80 μm, optionally greater than or equal to about 50 μm and less than or equal to about 70 μm, and optionally about 67 μm. A first distance between lines 39 may desirably be less than the spot size to ensure that the entire joining area 16 includes the crests 50, the troughs 52, and the micro-anchors 54. For example, when the spot size is about 67 mm, the first distance 39 between the lines 78 may be greater than or equal to about 20 μm to less than or equal to about 60 μm, optionally greater than or equal to about 25 μm and less than or equal to about 50 μm, and optionally about 50 μm. The first laser beam 70 may have a scan speed of greater than or equal to about 100 mm/s and less than or equal to about 10 m/s, optionally greater than or equal to about 200 mm/s and less than or equal to about 2 m/s, optionally greater than or equal to about 300 mm/s and less than or equal to about 1 m/s, and optionally about 500 mm/s. The first laser beam 70 may have a scan power of greater than or equal to about 50 W and less than or equal to about 500 W, optionally greater than or equal to about 100 W and less than or equal to about 400 W, optionally greater than or equal to about 200 W and less than or equal to about 300 W, and optionally about 240 W.

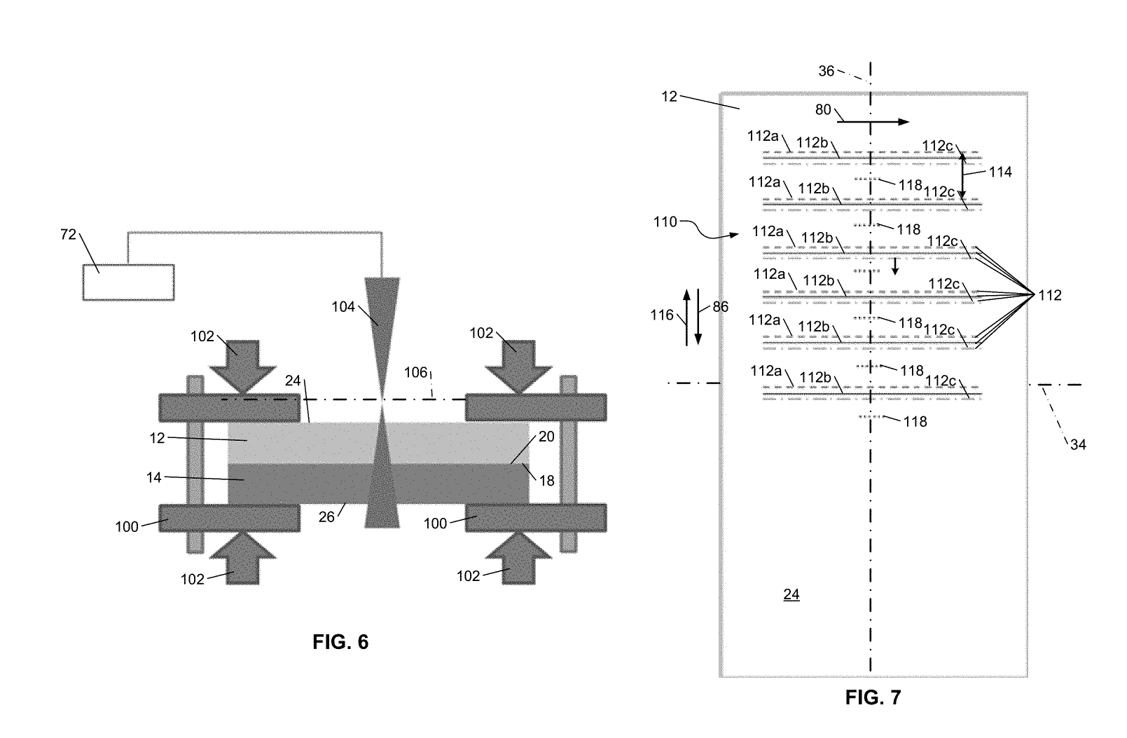

After the first surface 18 of the metal component 12 is laser treated to create the topography including the elongate peaks 28 and elongate valleys 30 having the crests 50, the troughs 52, the micro-anchors 54, and the micro-apertures (FIGS. 2A-2E), the metal component 12 may be joined to the reinforced polymeric composite component 14. The joining may include applying heat to the third surface 24 of the metal component 12 while the first surface 18 of the metal component 12 is in contact with the second surface 20 of the reinforced polymeric composite component 14. In certain variations, the heat source may be the laser source 72. With reference to FIGS. 6-7, the metal component 12 may be disposed on top of the reinforced polymeric composite component 14. The components 12, 14 may overlap partially (i.e., at the joining region 16) or fully (i.e., over an area larger than the joining region 16). The first surface 18 may be disposed toward the second surface 20. The first surface 18 may directly engage or contact the second surface 20. The components 12, 14 may both be disposed within clamps 100. A force 102 may be applied at the clamps 100 to maintain contact between the components 12, 14.

Joining the components 12, 14 may include directing a second laser beam 104 from the laser source 72 towards the third surface 24. The second laser beam 104 may be a continuous wave (CW) laser beam. A second focal plane 106 of the second laser beam 104 may be aligned above the third surface 24, as shown in FIG. 6, or below the third surface 24 (not shown). Thus, unlike the laser treatment of the first surface 18 shown and described in FIGS. 4-5, the second focal plane 106 is not aligned with the third surface 24. Instead, the second laser beam 104 may be defocused at the third surface 24. Defocusing the second laser beam 104 minimizes damage to the metal component 12 due to overheating and material vaporization. The second laser beam 104 may be defocused within a range of greater than or equal to about −3 mm to less than or equal to about +3 mm.

As discussed above, heat from the second laser beam 104 is transferred through the metal component 12 from the third surface 24 to the first surface 18 to heat the second surface 20 of the reinforced polymeric composite component 14. A first melting temperature of the metal component 12 may be greater than a second melting temperature of the polymer 60 of the reinforced polymeric composite component 14. For example, the metal component 12 may include aluminum having a melting temperature of about 660° C. and the reinforced polymeric composite component 14 may include nylon having a melting temperature of about 250° C.

A temperature of the first surface 18 of the metal component 12 may remain below the first melting temperature during the application of the second laser beam 104 so that the metal component 12 remains in a solid state near the joint 22. The temperature of the metal component at the first surface 18 may remain substantially below the first melting temperature to prevent or minimize damage to the metal component 12. A temperature of the reinforced polymeric composite component 14 at the second surface 20 may be greater than or equal to the second melting temperature so that a portion of the polymer of the reinforced polymeric composite component 14 melts and flows into the micro-anchors 54 (FIGS. 2A-2E). Thus, a temperature in the joining region 16 may be greater than the second melting temperature and less than the first melting temperature. For example, the temperature in the joining region 16 may be greater than or equal to about 300° C. and less than or equal to about 600° C. In some examples, a temperature of the third surface 24 of the metal component may be greater than the first melting temperature, resulting the third surface 24 being liquefied during the heating process.

The second laser beam 104 may move relative to the components 12, 14 to create a second laser pattern 110. For example, the laser head may move the second laser beam 104 while the components 12, 14 remain stationary. In another example, the components 12, 14 may be moved while the laser head remains stationary. The second laser pattern 110 may include a plurality of parallel lines 112. As discussed above, it may be desirable to avoid overheating the metal component 12. Thus, the second laser pattern 110 may be different than the first laser pattern 76 of the laser treatment for the first surface 18 (FIGS. 4-5). In one example, the second laser pattern 110 may include two or more subsets of lines 112, such as a first subset 112a, a second subset 112b, a third subset 112c, and so on. The laser head may move in the first direction 80 to create a first line of the first subset 112a. The laser head may then move in the second direction 86 and then in the first direction 80 to create another line 112a in the same subset. A second distance 114 between lines of the same subset may be greater than or equal to about 0.5 mm and less than or equal to about 5 mm. After the second laser beam 104 has completed the first scan set (e.g., moved through all of the lines 112a of the first subset), it may move in a third direction 116 opposite the second direction 86 to begin a second scan set. After the second laser beam 104 has completed the second scan set (e.g., moved through all of the lines 112b of the second subset), it may move in the third direction 116 to begin a third scan set. The above process may be repeated until the second laser pattern 110 is complete. As shown in FIG. 7, ellipses 118 in the second laser pattern 110 represent additional scan groups (e.g., to create a fourth subset and a fifth subset). In certain variations, the lines 112 of the second laser pattern 110 may be evenly spaced apart from one another. It may be desirable that the lines 112 do not overlap or cross one another to avoid overheating.

Although the second laser pattern 110 is shown as substantially aligned with the first axis 34 and substantially perpendicular to the second axis 36, alternative laser patterns are contemplated. Because the second laser beam 104 is used to heat the components 12, 14 rather than to form a particular topography, the orientation of the laser pattern may be varied. In one example, the laser pattern may be aligned with the second axis 36. In another example, the laser pattern may not be aligned with either axis 34, 36. A person skilled in the art would appreciate that any laser pattern that does not overheat and damage the metal component 12 may be employed.

The second laser beam may have a power of greater than or equal to about 500 W and less than or equal to about 2000 W, optionally greater than or equal to about 800 W and less than or equal to about 1800 W, optionally greater than or equal to about 1200 W and less than or equal to about 1500 W, and optionally about 1400 W. The second laser beam 104 may have a scan speed of greater than or equal to about 100 mm/s and less than or equal to about 2 m/s, optionally greater than or equal to about 300 mm/s and less than or equal to about 1.5 m/s, optionally greater than or equal to about 500 mm/s and less than or equal to about 1 m/s, and optionally about 750 mm/s. The second laser beam 104 may create a spot size of greater than or equal to about 100 μm and less than or equal to about 500 μm, optionally greater than or equal to about 120 μm and less than or equal to about 300 μm, optionally greater than or equal to about 150 μm and less than or equal to about 200 μm, and optionally about 180 μm.

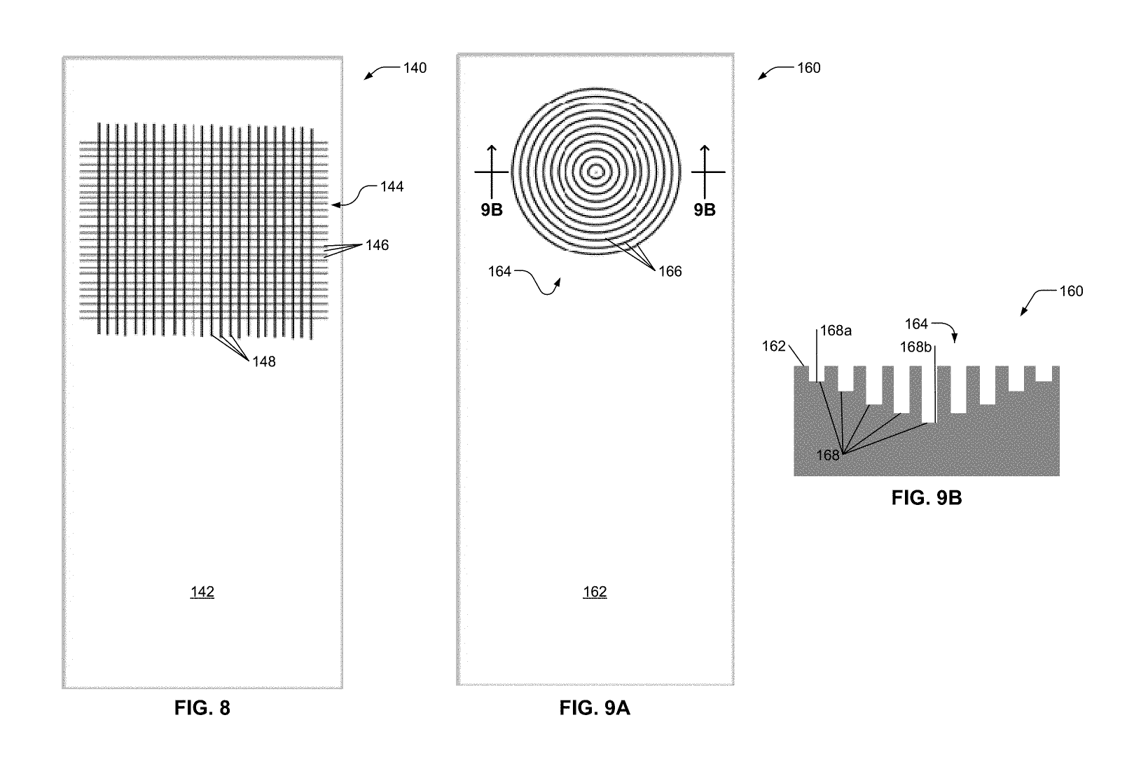

Referring now to FIGS. 8 and 9A-9B, alternative laser patterns for the laser surface treatment are shown. FIG. 8 depicts a metal component 140 having a first surface 142. A laser pattern 144 includes a first plurality of parallel lines 146 and a second plurality of parallel lines 148. The lines of the first plurality of parallel lines 146 are substantially perpendicular to the lines of the second plurality of parallel lines 148. Thus, when the metal component 140 is joined to a reinforced polymeric composite component, the resulting joint has a high lap shear strength in two directions.

FIG. 9A depicts a metal component 160 having a first surface 162. A laser pattern 164 includes a plurality of concentric circles 166. Thus, when the metal component 160 is joined to a reinforced polymeric composite component, the resulting joint has a 360° high lap shear strength. In certain embodiments, the concentric circles 166 of the laser pattern 164 may yield grooves 168 having different depths. For example, grooves 168a near a center of the concentric circles 166 may be deeper than outermost grooves 168b. The depth of a groove can be controlled by applying different laser power to create grooves having different depths (i.e., a higher power to create a deeper groove and a lower power to create a shallower groove) or applying different quantities of scans/passes for different grooves (i.e., more scans to create a deeper groove and fewer scans or a single scan to create a shallower groove).

### Example 1—Passivation Layer

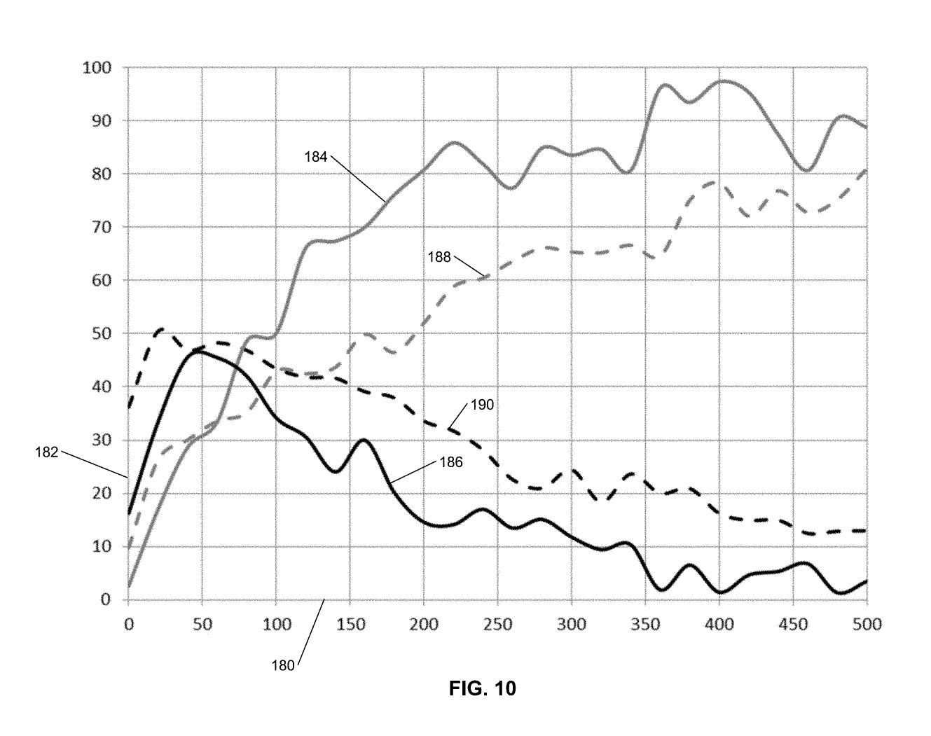

Referring now to FIG. 10, a first sample includes an aluminum component without a laser-treated surface. A second sample includes an aluminum component that has a laser-treated surface. X-ray photoelectron spectroscopy (XPS) is performed on the first and second samples to obtain depth profiles. An x-axis 180 represents depth measured in nanometers (nm) from a first surface (similar to the first surface 18) toward a third surface (similar to the third surface 24). A y-axis 182 represents an atomic percent of various components.

A first XPS depth profile 184 represents aluminum content in the first sample. A second XPS depth profile 186 represents oxygen content in the first sample. A third XPS depth profile 188 represents aluminum content in the second sample. A fourth XPS depth profile 190 represents oxygen content in the second sample. The atomic percentages shown for the first and second samples may not add up to 100% because XPS depth profiles of other components are omitted for readability (e.g., carbon, which is typically present in XPS depth profiles, is omitted).

A comparison of the second and fourth XPS depth profiles 186, 190 demonstrates that oxygen content is generally higher in the second sample, indicating the presence of an aluminum-oxide (Al₂O₃) passivation layer. The oxygen content in the first sample is consistently lower than the oxygen content in the second sample. For example, a surface oxygen content (at a depth of 0 nm) of the second sample is greater than about 35%. At a depth of about 100 nm, the second sample oxygen content is greater than about 40%. At a depth of about 200 nm, the second sample oxygen content is greater than about 30%. At a depth of about 250 nm, the second sample oxygen content is greater than about 25%. At a depth of about 300 nm, the second sample oxygen content is greater than about 20%. At a depth of about 400 nm, the second sample oxygen content is greater than about 15%. At a depth of about 500 nm, the second sample oxygen content is greater than about 10%.

### Example 2—Initial Lap Shear Strength and Degradation of Lap Shear Strength Over Time

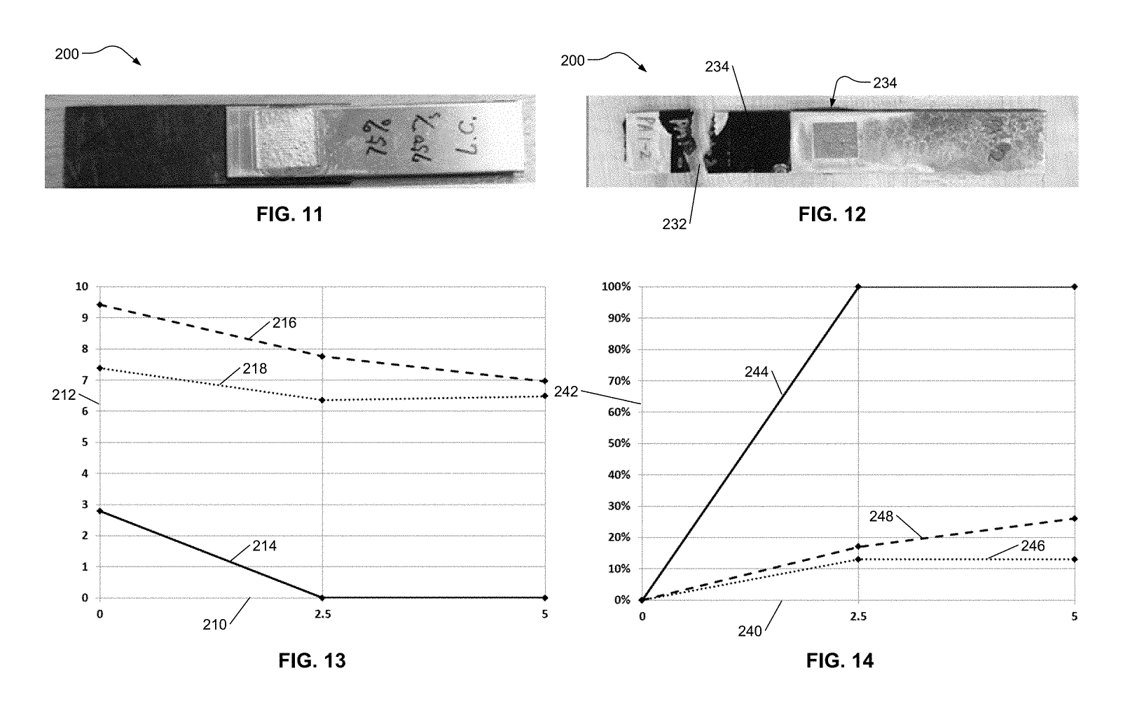

With reference to FIGS. 11-14, a first sample includes a metal-polymeric composite assembly having an aluminum component without a laser-treated surface. A second sample 200 includes a metal-polymeric composite assembly having an aluminum component that has a laser-treated surface. A third sample includes a metal-polymeric composite assembly having a stainless steel (316 stainless steel) component that has a laser-treated surface. Each of the first, second, and third samples includes a carbon-fiber reinforced nylon (nylon 6) composite having greater than or equal to about 20% and less than or equal to about 40% carbon fiber by weight.

Lap shear testing is performed to determine the lap shear strength of each of the samples. Similar samples are aged to test for corrosion. Referring to FIG. 13, an x-axis 210 represents age in years. A y-axis 212 represents lap shear strength in kN. A first curve 214 corresponds to the first sample, a second curve 216 corresponds to the second sample 200, and a third curve 218 corresponds to the third sample.

A typical strength requirement for automotive joints is 6 kN. A joint of the first sample is always less than 6 kN. Instead, the first sample has an initial lap shear strength of about 2.792 kN. The second and third samples both have initial lap shear strengths that exceed the 6 kN threshold. The second sample has an initial lap shear strength of about 9.415 kN. The third sample has an initial lap shear strength of about 7.382 kN.

Similar samples, which will also be referred to as first, second, and third samples (i.e., the first sample includes untreated aluminum, the second sample includes laser-treated aluminum, and the third sample includes laser-treated stainless steel), are aged to allow time for corrosion and tested at 2.5 years. The first sample corrodes over 2.5 years so that the joint is completely degraded at the 2.5 year mark. A joint of the second sample 200, which is believed to have an aluminum oxide (Al₂O₃) passivation layer disposed between the metal and the composite, remains intact after 2.5 years with a lap shear strength of about 7.760 kN. As shown in FIG. 12, after 2.5 years, a break 230 occurs in a reinforced polymeric composite component 232 of the first sample 200 after 2.5 years rather than at a joint 234. The third sample has a lap shear strength of about 6.355 kN after 2.5 years. Thus, both of the second and third samples having the laser-treated metal component remain about the 6 kN threshold after 2.5 years.

Additional similar samples, which will also be referred to as first, second, and third samples (i.e., the first sample includes untreated aluminum, the second sample includes laser-treated aluminum, and the third sample includes laser-treated stainless steel), are aged to allow time for corrosion and tested at 5 years. Again, the first sample corrodes so that the joint is completely degraded at the 5 year mark. A joint of the second sample 200, which is believed to have an aluminum oxide (Al₂O₃) passivation layer disposed between the metal and the composite, remains intact after 5 years with a lap shear strength of about 6.958 kN. The third sample has a lap shear strength of about 6.485 kN after 5 years. Thus, both of the second and third samples having the laser-treated metal component remain about the 6 kN threshold after 5 years.

Referring to FIG. 14, a percentage degradation of lap shear strength of the first, second, and third samples over time is shown. An x-axis 240 represents time in years. A y-axis 242 represents percentage degradation of lap shear strength ((initial lap shear strength−current lap shear strength)/initial lap shear strength). A first curve 244 corresponds to the first sample, a second curve 246 corresponds to the second sample 246, and a third curve 248 corresponds to the third sample. Degradation of the third sample, including stainless steel, is low when compared to the aluminum samples because stainless steel is not corrosive.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A metal-polymeric composite joint comprising:
a first component comprising a metal and having a first surface comprising a plurality of micro-anchors; and
a second component comprising a composite material comprising a polymer and a reinforcing fiber, the second component having a second surface at least partially engaging the first surface of the first component, wherein a portion of the polymer of the second component occupies at least a portion of the micro-anchors of the plurality of micro-anchors of the first component to fix the second component to the first component.

2. The metal-polymeric composite joint of claim 1, wherein the first surface further defines a plurality of crests and a plurality of troughs, the plurality of crests defining the plurality of micro-anchors.

3. The metal-polymeric composite joint of claim 2, wherein:
the first surface further defines a plurality of elongate valleys and a plurality of elongate peaks, the plurality of elongate valleys being disposed between the plurality of elongate peaks;
a portion of the plurality of crests and a portion of the plurality of troughs are disposed on each elongate valley of the plurality of elongate valleys; and
a portion of the plurality of crests and a portion of the plurality of troughs are disposed on each elongate peak of the plurality of elongate peaks.

4. The metal-polymeric composite joint of claim 3, wherein the plurality of elongate valleys and the plurality of elongate peaks are disposed parallel to one another, and the metal-polymeric composite joint can withstand loads of greater than or equal to about 6 kN in a direction perpendicular to the elongate valleys and the elongate peaks.

5. The metal-polymeric composite joint of claim 1, wherein the metal is selected from a group consisting of stainless steel, aluminum, and combinations thereof.

6. The metal-polymeric composite joint of claim 5, wherein:
the metal comprises aluminum; and
the first surface is at least partially coated in a passivation layer comprising aluminum oxide (Al₂O₃).

7. The metal-polymeric composite joint of claim 1, wherein the polymer is selected from the group consisting of a polycarbonate (PC), a high-density polyethylene (HDPE), polyoxymethylene (POM), a thermoplastic elastomer (TPE), acrylonitrile butadiene styrene (ABS), a thermoplastic olefin (TPO), a polyamide (PA, nylon), and combinations thereof.

8. The metal-polymeric composite joint of claim 1, wherein the metal comprises aluminum, the polymer comprises polyamide (PA, nylon), and the reinforcing fiber comprises a carbon fiber.

9. The metal-polymeric composite joint of claim 1, wherein at least a portion of the plurality of micro-anchors comprise micro-apertures, each micro-aperture having perimeter defining a connected shape.

10. A metal-polymeric composite joint comprising:
a first component comprising aluminum and having a first surface;
a second component fixed to the first component, the second component comprising a composite comprising a polymer and a reinforcing fiber, the second component having a second surface at least partially engaging the first surface of the first component; and
a passivation layer disposed on the first surface of the first component and engaging the second surface of the second component, the passivation layer comprising aluminum oxide (Al₂O₃), wherein the metal-polymeric composite joint has a lap shear strength of greater than or equal to about 6 kN after 5 years.

11. The metal-polymeric composite joint of claim 10, wherein the passivation layer has an average atomic percent of oxygen of greater than or equal to about 10% at a depth of 500 nm measured from the first surface of the first component.

12. A method of joining dissimilar materials comprising:
directing a first laser beam toward a first surface of a first component comprising metal, wherein the directing the first laser beam at the first surface of the first component forms a plurality of micro-anchors in the first surface;
disposing the first component on a second component comprising a composite comprising a polymer and a reinforcing fiber such that the first surface of the first component at least partially engages a second surface of the second component; and
directing a heat source towards a third surface of the first component, the third surface being disposed opposite the first surface, wherein the directing the heat source toward the third surface causes a portion of the polymer to melt and occupy a portion of the micro-anchors of the plurality of micro-anchors.

13. The method of claim 12, wherein:
the metal includes aluminum; and
the directing the first laser beam toward the first surface of the first component is performed in the presence of oxygen to form an aluminum oxide (Al₂O₃) layer on the first surface.

14. The method of claim 12, wherein the directing the heat source toward the third surface of the first component comprises directing a second laser beam toward the third surface of the first component, the second laser beam being a continuous wave (CW) laser beam.

15. The method of claim 14, wherein the second laser beam has a power of greater than or equal to about 500 W and less than or equal to about 2000 W, a scan speed of greater than or equal to about 100 mm/s and less than or equal to about 2 m/s, and a spot size of greater than or equal to about 100 μm and less than or equal to about 500 μm.

16. The method of claim 14, wherein the directing the second laser beam toward the third surface of the first component comprises moving the second laser beam with respect to the first component to create a first plurality of elongate valleys on the third surface, each elongate valley of the first plurality of elongate valleys being disposed substantially parallel to the other elongate valleys of the first plurality of elongate valleys, a centerline each elongate valley of the first plurality of elongate valleys being disposed greater than or equal to about 0.5 mm and less than or equal to about 5 mm from the centerline of each other elongate valley of the first plurality of elongate valleys.

17. The method of claim 16, wherein:
the directing the second laser beam toward the third surface of the first component further comprises moving the second laser beam with respect to the first component to create a second plurality of elongate valleys on the third surface, each elongate valley of the second plurality of elongate valleys being disposed substantially parallel to the other elongate valleys of the second plurality of elongate valleys, and a centerline each elongate valley of the second plurality of elongate valleys is disposed greater than or equal to about 0.5 mm and less than or equal to about 5 mm from the centerline of each other elongate valley of the second plurality of elongate valleys; and
the elongate valleys of the second plurality of elongate valleys are disposed between the elongate valleys of the first plurality of elongate valleys.

18. The method of claim 12, wherein the first laser beam is a nanosecond pulsed laser beam having a pulse width of greater than or equal to about 9 ns and less than or equal to about 200 ns, a pulse overlap of greater than or equal to about 0% and less than or equal to about 50%, and a repetition rate of greater than or equal to about 10 kHz and less than or equal to about 500 kHz.

19. The method of claim 12, wherein the first laser beam has a scan power of greater than or equal to about 50 W and less than or equal to about 500 W, a scan speed of greater than or equal to about 100 mm/s and less than or equal to about 10 m/s, and a spot size of greater than or equal to about 10 μm and less than or equal to about 100 μm.

20. The method of claim 12, wherein the metal comprises aluminum, the polymer comprises polyamide (PA, nylon), and the reinforcing fiber comprises carbon fiber.
